(19) United States
(12) Patent Application Publication
(10) Pub. No.: US 2013/0309899 A1
(43) Pub. Date: Nov. 21, 2013

(54) CONNECTOR AND SYSTEM FOR COOLING ELECTRONIC DEVICES

(71) Applicants: Maninder S. Sehmbey, Hoffman Estates, IL (US); Morris B. Bowers, Grayslake, IL (US)

(72) Inventors: Maninder S. Sehmbey, Hoffman Estates, IL (US); Morris B. Bowers, Grayslake, IL (US)

(73) Assignee: MOTOROLA MOBILITY, INC., Libertyville, IL (US)

(21) Appl. No.: 13/471,486

(22) Filed: May 15, 2012

(51) Int. Cl. H01R 13/00

(52) U.S. Cl. 439/485

(57) ABSTRACT

An electrical connector (130) is configured to draw heat out of a portable electronic device (100). The electrical connector (130) can include an electrical connection portion and a housing (131). A thermal conduit (132) is coupled to the housing (131) at a connection (536). The connection (536) is configured to transfer heat between the thermal conduit (132) and the housing (131). The electrical connector (130) can be coupled to a second electrical connector (660), which can be coupled to a heat sink (1015) to draw heat from the portable electronic device (100) through the connectors to the heat sink (1015), thus obviating the need to incorporate fans or other cooling devices in the portable electronic device (100).

### BACKGROUND

1. Technical Field

This invention relates generally to electronic devices, and more particularly to a connector system for electronic devices.

2. Background Art

Communication technology is constantly evolving. For instance, there was a time when the only way to make a telephone call was across a copper wire with the assistance of a human operator. Today, by contrast, people are able to call others around the world with a variety of communication devices, including cellular telephones, satellite telephones, and network-based communication systems such as voice over Internet protocol phone devices that function with the assistance of a computer or other specialized hardware. In addition to these voice-based channels, people may communicate via electronic mail, text messaging, videoconferences, and multimedia messaging as well.

With the advent of new communication protocols and technologies, device manufacturers are continually designing more features into their handsets. These features frequently require more powerful processors and control circuits. These processors and control circuits tend to consume more power than their predecessors. The increase in power consumption causes an increase in heat being generated in an electronic device. If the heat is not removed, the processor or control circuit may reach thermal limitations, thereby limiting the circuit's performance.

It would be advantageous to be able to cool active components of electronic devices so that performance would not be limited by thermal constraints.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates one explanatory portable electronic device, along with a schematic block diagram and a network schematic, configured in accordance with one or more embodiments of the invention.

FIG. 2 illustrates one explanatory portable electronic device operating in a first operating system environment of a dual-operating system hybrid environment in accordance with one or more embodiments of the invention.

FIGS. 3, 4, and 11 illustrate explanatory portable electronic devices being coupled to peripheral hardware devices to launch a dual-operating system hybrid environment in accordance with one or more embodiments of the invention.

FIG. 5 illustrates a diagram of one explanatory connector configured in accordance with one or more embodiments of the invention.

FIG. 6 illustrates one explanatory electrical connector configured in accordance with one or more embodiments of the invention.

FIGS. 7-9 illustrate alternate explanatory electrical connectors configured in accordance with one or more embodiments of the invention.

FIG. 10 illustrates one cut-away view of a portable electronic device with one embodiment of a connector assembly configured in accordance with one or more embodiments of the invention.

FIGS. 12 and 13 illustrate alternate cut-away views of electronic devices with explanatory embodiments of connector assemblies configured in accordance with one or more embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF EMBODIMENTS OF THE INVENTION

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing FIG. A would refer to an element, 10, shown in figure other than FIG. A.

Embodiments of the present invention provide an electrical connector, and electrical devices employing such connectors, where the connector is configured to transfer heat from internal components to external devices. In one or more embodiments, the external devices comprise heat-sinking capabilities, thereby allowing the external devices to dissipate heat generated in a primary device.

For example, in one embodiment an electrical connector includes an electrical connection portion. The electrical connector portion includes one or more electrical contacts, and can be used for communicating data and delivering power to or from an electrical device employing the electrical connector. The electrical connector also includes a housing. In one embodiment, a thermal conduit is mechanically coupled to the housing at a connection point such that a thermal conduit is formed between the thermal conduit and the connection point. Examples of thermal conduit suitable for use with embodiments of the invention include heat pipes, thermally conducting fibers, ribbons, and films, such as carbon based ribbons, and thermal couplers and coupling devices. Other examples of thermal conduit will be readily apparent to those of ordinary skill in the art having the benefit of this disclosure.

The other end of the thermal conduit can be thermally coupled to one or more heat generating components within the electrical device, such as processors, power supplies, transceiver circuits and so forth. By thermally connecting the thermal conduit between the heat generating component and the housing of the connector, heat can be transferred from the heat-generating component to the connector housing. When the housing is coupled to a complementary, thermally conductive connector housing in a second, external device, the heat can be transferred through the mated connector housings to the second device. Where the second device includes another thermal conduit coupled between its housing and the heat-sinking element, the heat can be dissipated from the heat generating component, through the connector system, to the heat-sinking element. The connectors and connector systems described herein thus allow a convenient mechanism for removing heat from small electronic devices through the housings of their connectors. This, in turn, allows the processors and internal components of the small electronic device can run at higher speeds and deliver enhanced performance when connected to an external device without the need of incorporating a fan or other cooling system into the small electronic device.

Accordingly, by using a connector or connector assembly configured in accordance with one or more embodiments of the invention, heat can be moved from an electronic device to a docking station, adaptor, or other device through the connector assembly. The heat can then be dissipated in the auxiliary device using a heat-sinking device, such as a small fan or thermally conductive structure employing natural convection. As noted above, this method of heat removal—through a connector—eliminates a need to incorporate a fan or other cooling mechanism in the primary electronic device, thereby allowing the primary device to remain compact without sacrificing performance. Connectors and connector assemblies configured in accordance with one or more embodiments of the invention can incorporate combinations of heat pipes, conducting tapes or plates, carbon films, and/or thermally conductive devices as thermal conduit to move heat from a primary device through, for example, a complementary connector in a docking device to a heat transfer system in the docking device. The heat can then be moved to a heat-sinking device using a heat pipe and then ultimately dissipated to the air either using a fan or through natural convection, depending on the size and/or volume of the docking device.

In one explanatory portable electronic device that can be configured with the thermally conductive electrical connectors described herein, the portable electronic device includes one or more processors disposed within the device that are configured for operation in a dual-operating system hybrid environment. A first operating system environment is active during normal, mobile operation. However, in certain use cases, such as when the device is coupled to a peripheral hardware component having a dual-operating system hybrid environment license, the device can enter a second operating system environment having enhanced data usage capabilities.

When entering the second operating system environment, the power requirements of the one or more processors can increase rapidly. Accordingly, the portable electronic device can be equipped with an electrical connector having a housing disposed about electrical contacts. A thermal conduit can couple the housing and circuit components within the portable electronic device that are configured to generate heat, such as the one or more processors. The thermal conduit will then transfer heat from the heat-generating circuit component to the connector housing and into the peripheral hardware component. The heat can then be dissipated with a heat sinking mechanism present in the peripheral hardware component.

In one embodiment, the dual-operating system hybrid environment is referred to as a “WebTop” environment, in that the device has access to two simultaneous operating system environments. The first operating system environment is a standard mobile operating environment, where the device is configured to interact with a wide area network using standard wide area network data rates and usage modes. Power consumption within the device is generally limited by thermal constraints when operating in the first operating system environment.

The second operating system environment gives rise to an enhanced data usage rate, in that the second operating system environment includes an enhanced, full, multi-window desktop environment where the device can access a desktop class web browser and web applications, which are similar to those normally found only on a personal computer. In this second mode of operation, the device also runs the first operating system environment, and accordingly presents one or more dedicated windows that display the content and results of operational steps in the first environment. These windows can be referred to as the “Mobile View” of the WebTop. A user can start, stop, or interact with the first environment applications inside a Mobile View window. The dual-operating system hybrid environment enables the user to access a full desktop computer web browsing experience with a mobile device, e.g., viewing the full desktop versions of Internet websites that include Adobe Flash 10™ based websites through the portable electronic device's built-in web browser and web application framework.

By nature of their design, WebTop applications operating in the second operating system environment download orders of magnitude more data than do the mobile applications operating in the first operating system environment. Accordingly, such WebTop applications require an enhanced data usage rate, which requires the circuit components disposed within the portable electronic device to consume far more power and, therefore, generate far more heat. Since a docking station is required in some embodiments for the portable electronic device to enter the WebTop mode, connector systems configured in accordance with one or more embodiments of the invention advantageously allow heat to be drawn from the portable electronic device through the connector system to the docking station. This allows the portable electronic device to deliver high-performance, WebTop applications without the need of integrating a fan or active cooling system into the portable electronic device.

When using a connecting system configured in accordance with embodiments of the invention, a first electronic device, e.g., the portable electronic device, can be configured with a first electrical connector having a first connector housing that is thermally conductive. A heat-generating component, such as a processor capable of operating in both a mobile mode and a WebTop mode, can be disposed within the first electronic device. A first thermal coupler can then couple the first connector housing and the heat generating circuit component.

A second electronic device, e.g., the docking station, can then include a second electrical connector having a second connector housing that is both thermally conductive and complementary with the first connector housing. A heat-sinking element, such as a fan, finned convection heat sink, or combination thereof, can then be disposed within the docking station. A second thermal coupler can be thermally coupled between the second connector housing and the heat-sinking element such that heat is drawn from the connector system to the heat-sinking element for dissipation.

As embodiments of the invention are well suited for electronic devices configured for dual mode operation, due in part to the use of a docking device, a dual mode electronic device will be used herein for explanatory purposes in describing electrical connectors and connector systems configured in accordance with one or more embodiments of the invention. However, it will be clear to those of ordinary skill in the art having the benefit of this disclosure that the connectors and connector systems described herein are not limited to dual mode operation devices. To the contrary, the connectors and connector systems can be used in any number of more traditional electronic devices as well. For example, a connector system configured in accordance with one or more embodiments of the invention can be used to draw heat from an electronic device through a connector system when the device is coupled to a charger.

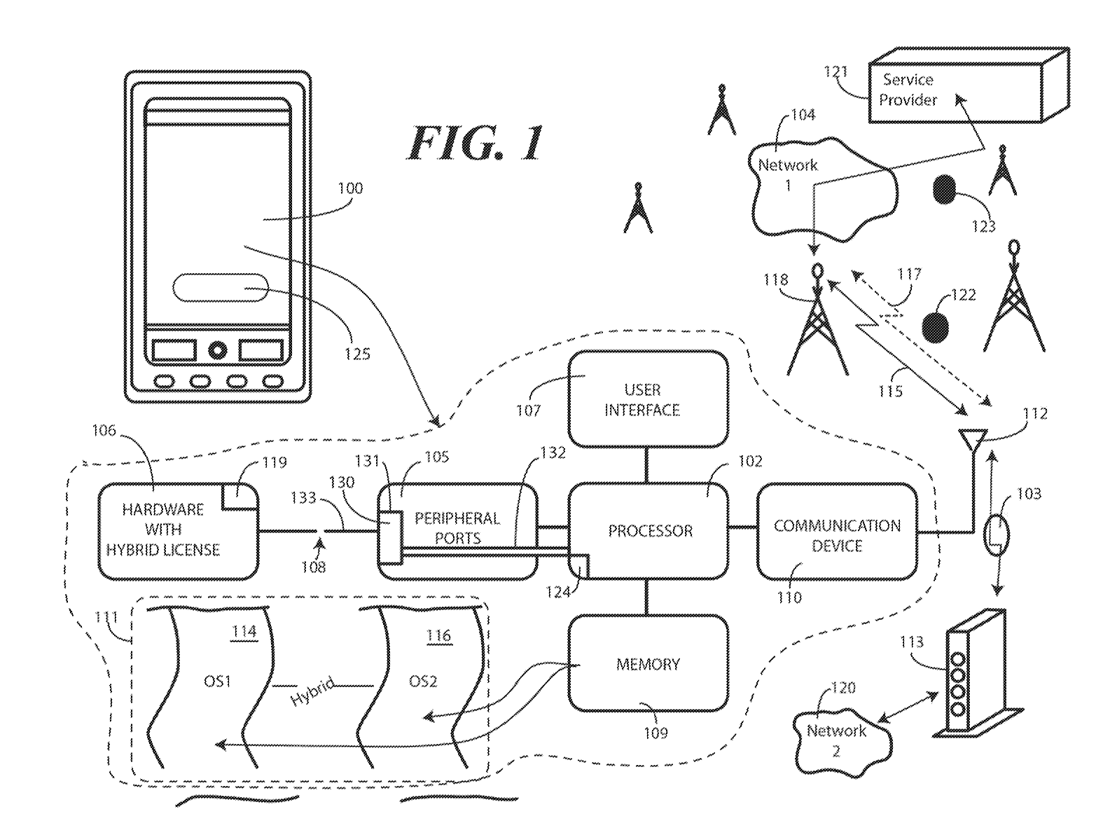

Using a dual mode operation device as an illustrative example, and turning now to FIG. 1, illustrated therein is one embodiment of an explanatory portable electronic device 100 configured for communication with a wide area network 104. The illustrative portable electronic device 100 of FIG. 1 is shown as a smart phone for illustration. However, it will be obvious to those of ordinary skill in the art having the benefit of this disclosure that other portable electronic devices may be substituted for the explanatory smart phone of FIG. 1. For example, the portable electronic device 100 may be configured as a palm-top computer, a tablet computer, a gaming device, a media player, or other device.

The illustrative portable electronic device 100 may include standard components such a user interface 107 and associated modules. The user interface 107 can include various combinations of a display, a keypad, voice control modules, and/or touch sensitive interfaces. The portable electronic device 100 includes a communication device 110. The communication device 110 is configured for communication with one or more networks 104,103,120, and can include wireless communication circuitry, one of a receiver, a transmitter, or transceiver, and an antenna 112.

The communication device 110 can be configured for data communication with at least one wide area network 104. For illustration, the wide area network 104 of FIG. 1 is shown as a cellular network being operated by a service provider 121. Examples of cellular networks include GSM, CDMA, W-CDMA, CDMA-2000, iDEN, TDMA, and other networks. It should be understood that the communication device 110 could be configured to communicate with multiple wide area networks as well, with one being shown in FIG. 1 for simplicity.

The portable electronic device 100 can optionally be configured to communicate with a local area network 103, such as the WiFi network being supported by a local area network router 113. Local area networks can be connected through communication nodes, e.g., local area network router 113, to other networks, such as the Internet, which is represented by network 120 in FIG. 1. For example, the local area network 103 can provide data communication through a non-IP Multimedia Subsystem (non-IMS) channel.

The portable electronic device 100 includes one or more processors 102, which are responsible for performing the functions of the device. The one or more processors 102 can be a microprocessor, a group of processing components, one or more Application Specific Integrated Circuits (ASICs), programmable logic, or other type of processing device. The one or more processors 102 are operable with the user interface 107 and the communication device 110, as well as various peripheral ports 105 that can be coupled to peripheral hardware devices 106 via interface connections 108. The one or more processors 102 process and execute executable software code to perform the various functions of the portable electronic device 100.

A storage device 109, such as a memory module, stores the executable software code used by the one or more processors 102 for device operation. The storage device 109 may also store identification information suitable for identifying the portable electronic device 100 or its user to the service provider 121. In one embodiment, the identification information includes information identifying the user and the type of subscription held by the user for wireless communication services.

The one or more processors 102 can be configured to host a dual-operating system hybrid environment 111. A first operating system environment 114 can be configured for normal data rate communication 115 with the wide area network 104. This “normal” data rate communication 115 is referred to as “Mobile Communication” and can be used for voice calls, mobile device web browsing, text and multimedia messages, and so forth. Typical normal data rate communication 115 occurs with data being exchanged below one megabit per second.

The second operating system environment 116 is operable to communicate with the wide area network 104 using enhanced data rate communication 117. One example of the second operating system environment 116 is the WebTop environment discussed above, in which enhanced, full, multi-window desktop environments can be used, where the portable electronic device 100 can access a desktop class web browser and web applications, which are similar to those normally found only on a personal computer. “Enhanced” data rates can vary by service provider and technology. In general terms, a particular service provider will offer both a normal throughput in bits per second and a maximum allowed data limit in total bits downloaded and/or uploaded per month. For discussion purposes, one example of an enhanced data rate communication 117 include communication occurring at data rates in excess of one megabit per second, such as the enhanced fourth generation enhanced data transmission speeds that are in excess of two megabits per second. It will be clear to those of ordinary skill in the art that the enhanced data rate can change as technology is developed or across service providers.

When using an enhanced data rate, the one or more processors 102 can draw more power due to the need to process more data. Drawing more power generates more heat. To provide thermal management for this enhanced performance, in one embodiment at least one of the peripheral ports 105 includes an electrical connector 130 having a housing 131. The housing 131 can be manufactured with a material having a high thermal conductivity. Examples of such materials include copper, aluminum, and alloys thereof, as well as carbon-based materials. In one embodiment, the housing 131 is disposed about electrical contacts 133. Data and power can be drawn through the electrical contacts 133 so that the portable electronic device 100 can optionally communicate with and/or be powered by a peripheral hardware device 106.

The electrical connector 130, in one embodiment, also includes a thermal conduit 132 that couples the housing 131 and a circuit component within the portable electronic device 100 that is configured to generate heat. For illustration purposes, presume the primary heat-generating component is the one or more processors 102 of the portable electronic device 100. The thermal conduit 132 can be mechanically and/or thermally coupled to the one or more processors 102 such that the heat generated by the one or more processors 102 is transferred from the one or more processors 102 to the housing 131 of the electrical connector 130.

Note that while the thermal conduit 132 is thermally coupled between the one or more processors 102 and the housing 131 in this illustration, the thermal conduit 132 could be thermally coupled between other circuit components configured to generate heat as well. For example, the thermal conduit 132 could be thermally coupled between a transceiver and the housing 131, a display and the housing 131, an application specific circuit and the housing 131, and so forth. Moreover, note that the thermal conduit 132 can be coupled between multiple circuit components configured to generate heat and the housing 131 as well. For example, the thermal conduit 132 could couple the housing 131 to multiple circuit components disposed within the portable electronic device 100 simultaneously. Additionally, the thermal conduit 132 could comprise a plurality of thermal conduit devices as well.

In one embodiment, the thermal conduit 132 comprises a heat pipe. Heat pipes are known in the art. Typically, a heat pipe includes a sealed pipe made of a thermally conductive material. Examples include copper, aluminum, and corresponding alloys. In some embodiments, the heat pipe includes the thermally conductive material only at the ends, with other materials disposed therebetween. Air is generally removed from the heat pipe. The heat pipe is then partially filled with a fluid, such as water. Other coolants can optionally be used. Since the air is removed and the heat pipe is only partially filled with fluid, an effective vacuum can be created with a pressure that is at or below the vapor pressure of the fluid. This causes some of the fluid to be in the liquid phase while other portions of the fluid are in the gaseous phase. An optional wicking structure can be included within the heat pipe to facilitate capillary flow of the liquid within the heat pipe. The “tube” of the heat pipe can be round, flat, or have other geometries.

Evaporation from heat and condensation at cooler surfaces work to transfer thermal energy from hot regions to cooler regions. When a hot surface is thermally coupled to one end of a heat pipe, and a cooler surface is thermally coupled to the other end, a temperature differential across the heat pipe is created. The fluid inside the pipe tends to evaporate at the hot end, thereby increasing the pressure within the pipe. This evaporation draws heat from the hot end. Condensation at the other end transfers the heat out of the pipe. Liquid flow within the pipe repeats the process.

Heat pipes are not the only devices that can be used as the thermal conduit 132. Other thermally conductive elements can be used as well. For example, in one embodiment the thermal conduit 132 comprises a thermal conductor such as a thermally conductive graphite film, fiber, or ribbon. Multiple thermal conductors can also be used. In another embodiment, the thermal conduit 132 comprises thermal conductors made from sheets, ribbons, or films of copper or aluminum or alloys thereof. Other thermal transfer devices configured to transfer heat from one location to another will be obvious to those of ordinary skill in the art having the benefit of this disclosure.

In one or more embodiments, when the second operating system environment 116 is launched, for a user to use enhanced data rate communication 117, an authentication check is performed to ensure that the subscription plan associated with the user permits enhanced data rate communication 117. To perform the authentication, in one embodiment the one or more processors 102 initially confirm that data communication is possible between the communication device 110 and the wide area network 104. This will generally be the case when the portable electronic device 100 is within range of the wide area network 104, e.g., is within the communication radius of a tower 118 of the wide area network 104, and where the communication device 110 is active. Data communication would not be possible in cases where, for example, the portable electronic device was OFF, or where the portable electronic device 100 had been placed in a “airplane mode” or other mode that disables the wide area communication capabilities of the communication device 110.

The one or more processors 102 then initiate the dual-operating system hybrid environment 111 by making the first operating system environment 114 and the second operating system environment 116 simultaneously operative. In many applications, the first operating system environment 114 will be continually active, while the second operating system environment 116 is selectively activated. For example, in one embodiment the second operating system environment 116 is activated when a peripheral hardware device 106 that includes a dual-operating system license key 119 is coupled to an interface connection 108 in communication with the one or more processors 102. Examples of peripheral hardware devices 106 include external displays, docking stations, peripheral connectors, and so forth, some of which will be shown below.

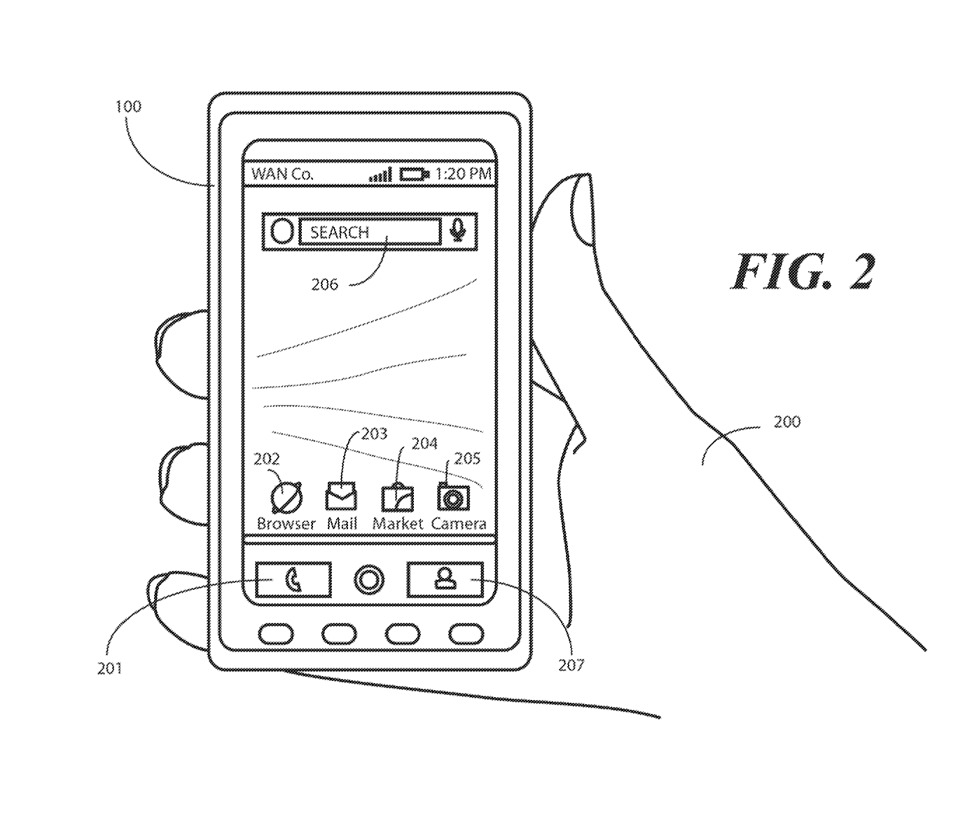

Turning to FIG. 2, a user 200 is holding the portable electronic device 100 of FIG. 1. The portable electronic device is operating in the first operating system environment (114). Since the portable electronic device 100 must remain relatively cool so as to be capable of being held, the operation of the internal components is generally thermally limited while operating in this first operating system environment (114). In this illustrative example, the first operating system environment (114) is a smart cellular telephone mode. The first operating system environment (114) has associated therewith various applications capable of operating at normal data rate communication (115). Examples of such applications include a cellular telephone application 201, a mobile web browser application 202 configured for operation at data rates under 1.5 megabits per second, an Internet shopping application 204, a camera application 205, an Internet search application 206, and a social media application 207. These applications are illustrative only, as others will be obvious to one of ordinary skill in the art having the benefit of this disclosure. Each of the applications has a common element, however, in that it is operable at reduced data rates so as not to overly tax cellular or other wide area networks.

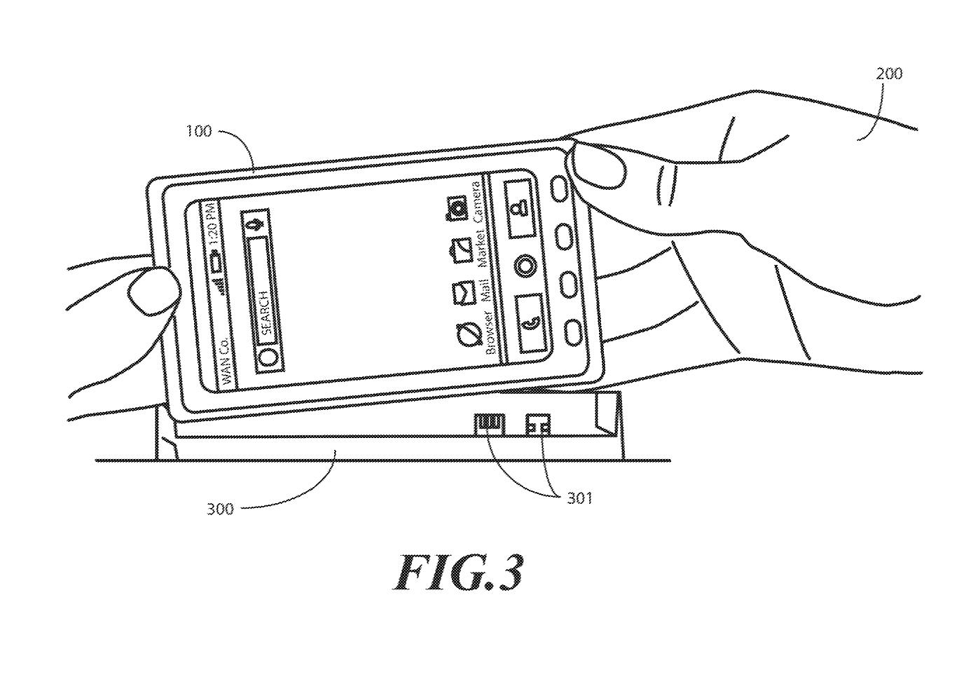

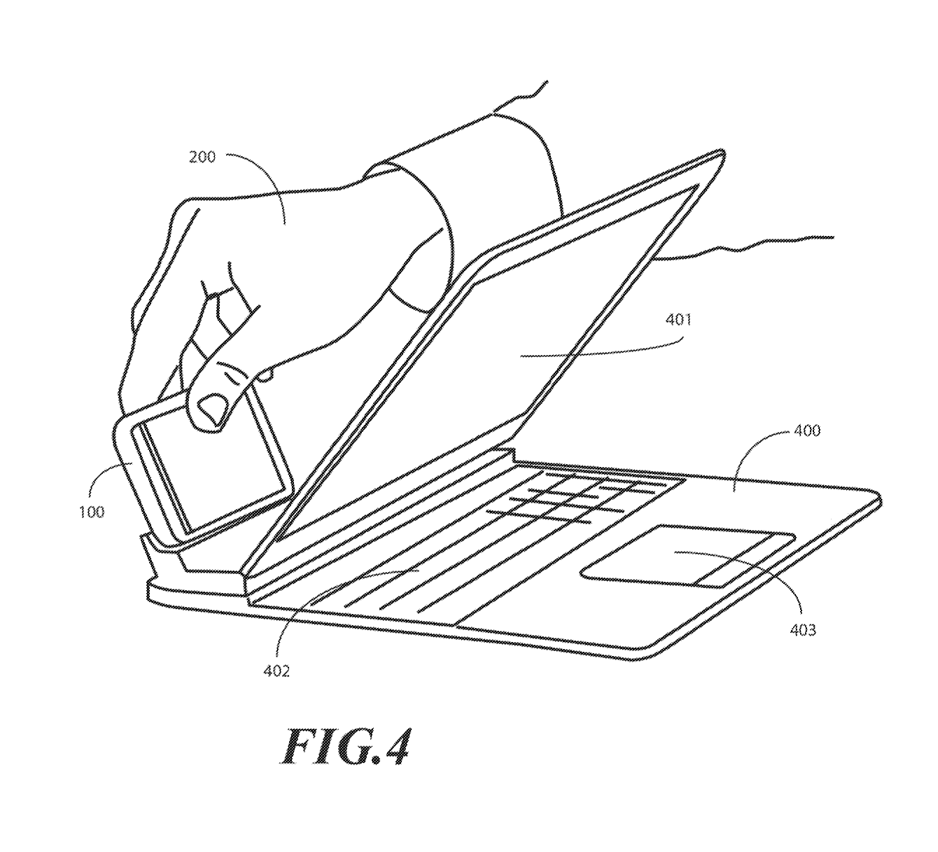

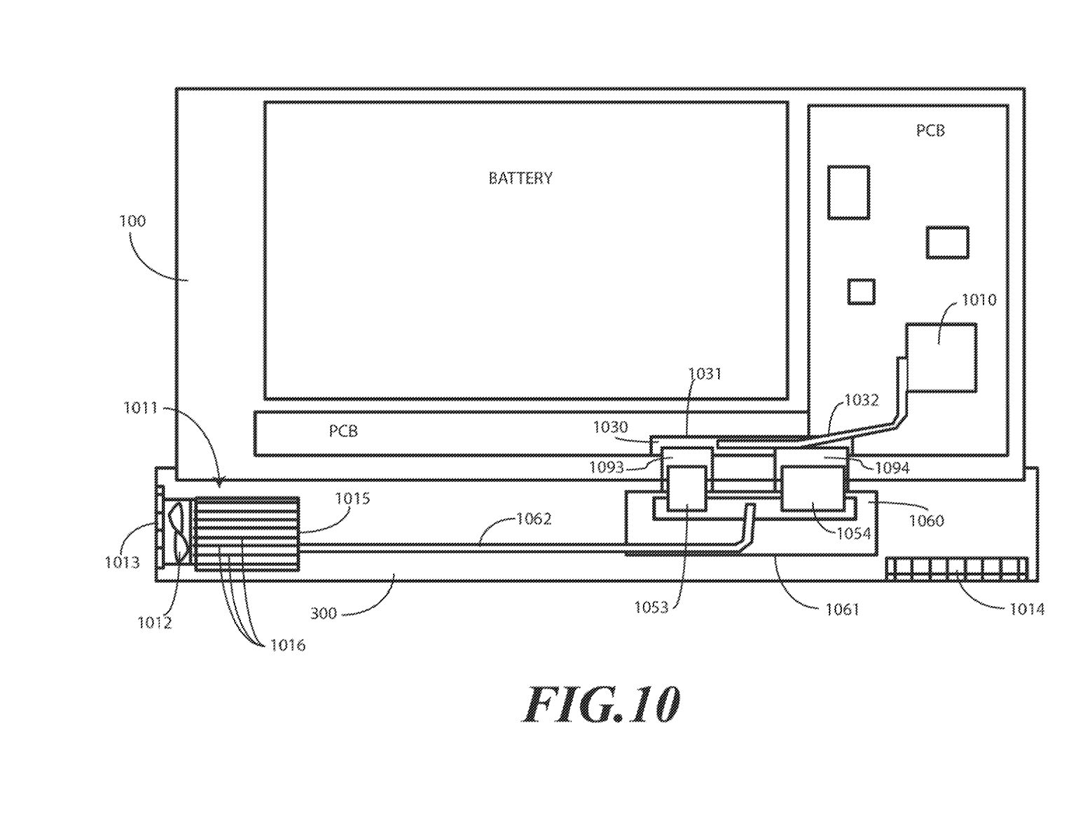

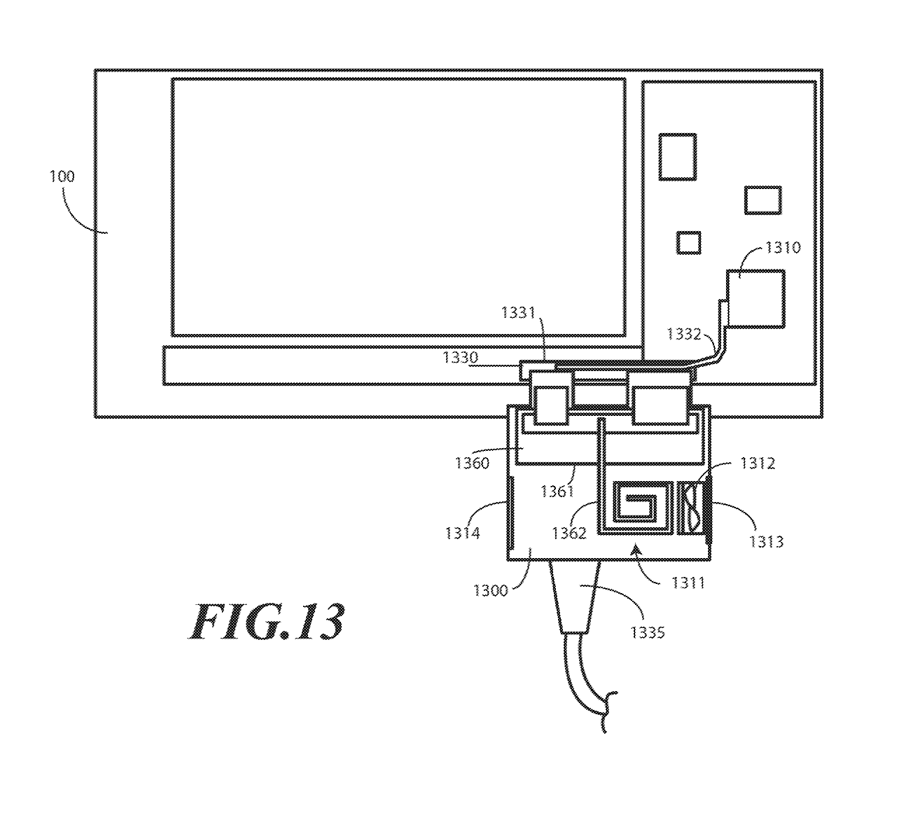

Turning now to FIG. 3, the user 200 is shown coupling the portable electronic device 100 to a peripheral hardware device (106). The peripheral hardware device (106) of the illustrative embodiment of FIG. 3 is a peripheral device 300 that delivers one or more signals from the electrical contacts (133) of the electrical connector (130) of the portable electronic device 100 to an external device. In one embodiment, the peripheral device 300 comprises a connector, as will be shown below in FIG. 13. In another embodiment, the peripheral device 300 comprises a docking stand, as will be shown in FIG. 10 below. In yet another embodiment, the peripheral device 300 comprises a lap dock, as will be shown in FIG. 4. Other types of peripheral devices will be obvious to those of ordinary skill in the art having the benefit of this disclosure.

Note that the electrical connector (130) of the portable electronic device 100 is not visible in the illustrative embodiment of FIG. 3 because the portable electronic device 100 is shown face on, while the electrical connector (130) is disposed on, and recessed into, the side of the portable electronic device 100 so that an insertion port of the electrical connector (130), which is complementary to one or more connectors 301 of the peripheral device 300, is flush with a major face (the side) of the portable electrical device 100.

In one embodiment, in addition to making the portable electronic device 100 operable with a peripheral component, the peripheral device 300 may also include a dual-operating system license key (119) stored in an on-board memory device. The one or more processors (102) of the portable electronic device 100 can be configured to retrieve the dual-operating system license key (119) and then launch the second operating system environment (116). Examples of peripheral devices 300 can include cable connectors, such as connectors for HDMI cables, USB cables, and so forth.

Where this is the case, coupling the portable electronic device 100 to the peripheral device 300 will cause additional heat to be generated within the portable electronic device 100, as the portable electronic device 100 will enter an enhanced performance mode. Said differently, launching the second operating system environment (116) causes the power drawn by the one or more processors (102) to significantly increase, which in turn generates more heat. Embodiments of the invention work to draw this additional heat through the electrical connector (103) to the one or more connectors 301 of the peripheral device 300 so that the additional heat can be dissipated in a heat sinking device disposed within the peripheral device 300. This will be explained in more detail in FIG. 10 below.

Turning now to FIG. 4, rather than connecting the portable electronic device 100 to a peripheral device (300), the user 200 is connecting the portable electronic device 100 to a docking station 400 to place the portable electronic device 100 in the enhanced operating mode. In this illustrative embodiment, the docking station 400 includes an external display 401 (external with reference to the portable electronic device 100), a full QWERTY keyboard 402, and a touchpad 403. Applications configured for operation in the second operating system environment (116) can be presented on the external display 401. In the system of FIG. 4, the portable electronic device 100 couples to the docking station to resemble a traditional laptop computer.

As with the embodiment of FIG. 3, coupling the portable electronic device 100 to the docking station 400, thereby launching the enhanced operating mode of the second operating system environment (116), will cause additional heat to be generated within the portable electronic device 100 due to the extra power consumption required by the internal components. Embodiments of the invention work to draw this additional heat through the electrical connector (103) to the one or more connectors of the docking station 400 so that the additional heat can be dissipated in a heat sinking device disposed within the docking station 400.

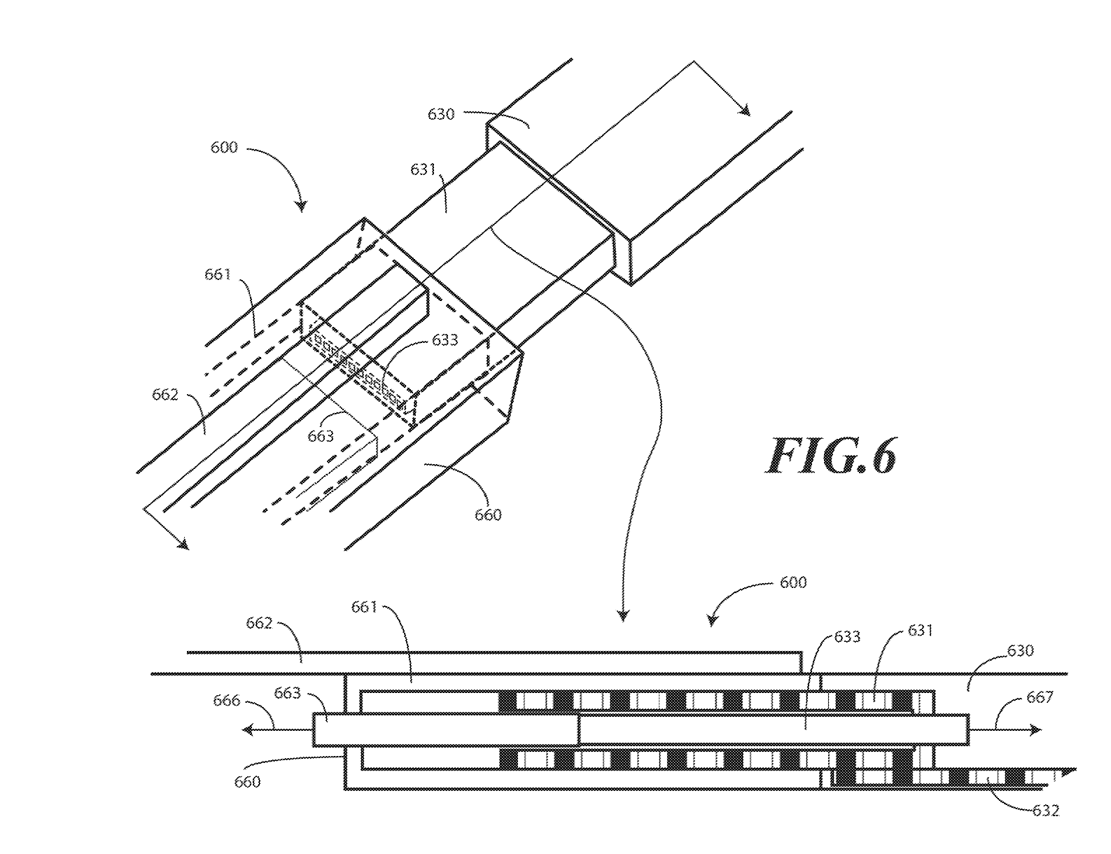

In some embodiments, the docking station 400 includes active components such as a fan. Embodiments of the invention allow these active components to be placed in devices external to the portable electronic device 100 so that they can be used when the portable electronic device is operating in the enhanced mode. This allows the portable electronic device 100 to remain compact for portable use in one operating environment, while at the same time remain thermally stable due to the heat removal through the electrical connector (130) when coupled to the docking station 400. This will be explained in more detail in FIG. 6 below.

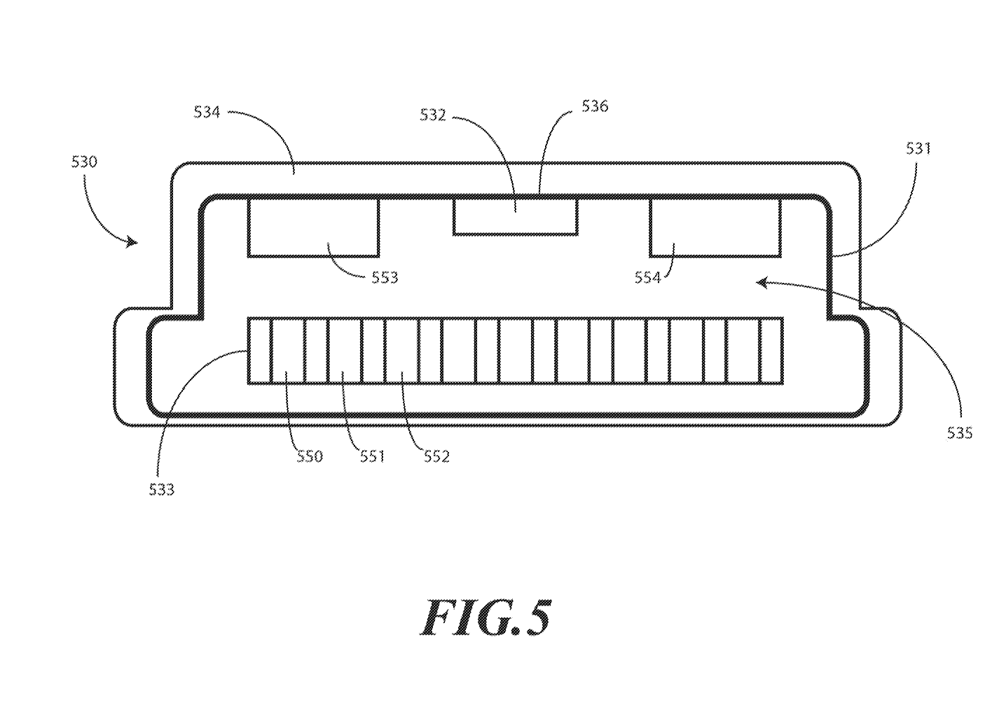

Turning now to FIG. 5, illustrated therein is a block diagram of one explanatory electrical connector 530 configured in accordance with one or more embodiments of the invention. The electrical connector 530 can be configured in accordance with a variety of standards, including USB, mini-USB, HDMI, Ethernet, and so forth.

The electrical connector 530 of this illustrative embodiment includes an electrical connection portion 533 comprising one or more electrical contacts, e.g., electrical contacts 550, 551, 552. Some of the electrical contacts, e.g., electrical contact 550, can be used to deliver power to the electronic device employing the electrical connector 530. Other electrical contacts, e.g., electrical contacts 551, 552, can be used to transfer data to and from the electronic device employing the electrical connector 530.

In one embodiment, a housing 531 is disposed about the electrical connection portion 533. It will be clear to those of ordinary skill in the art having the benefit of this disclosure, however, that the opposite configuration could also be used. To wit, the housing 531 could be disposed within the electrical connection portion 533 such that the frame or mechanical portion of the electrical connection portion 533 surrounds the housing. Similarly, while the electrical connection portion 533 is shown as being disposed within the housing 531 in FIG. 5, the electrical connection portion 533 could be disposed outside the housing 531 and adjacent to one of the housing walls. Other configurations of the electrical connection portion 533 with respect to the housing 531 will be obvious to those of ordinary skill in the art having the benefit of this disclosure.

In one embodiment, the housing 531 is manufactured from a material having a high thermal conductivity. Examples of materials suitable for manufacture of the housing include copper, aluminum, copper alloys, aluminum alloys, and carbon-based materials such as graphite or other carbon composite materials.

A thermal conduit 532, which may be for example a heat pipe or carbon-based or metal-based film, fiber, or ribbon, is then mechanically coupled to the housing 531 at a connection 536. The connection 536 is configured to transfer heat between the thermal conduit 532 and the housing 531.

In one or more embodiments, the electrical connector 530 comprises an optional thermally insulating covering 534 disposed about the housing 531. Examples of thermally insulating coverings 534 include silicone, rubber-based coatings, or other coatings. Recall from above that in some embodiments, the electrical connector 530 is recessed into the electrical device employing it such that an insertion port 535 of the electrical connector 530 is flush with a major face of the electrical device. However, in other embodiments, the electrical connector 530 protrudes from either the electrical device or a peripheral device, or is configured so as to rotate, slide, or selectably protrude from either the electrical device or the peripheral device. In some of these embodiments, a designer may elect to employ the thermally insulating covering 534 to prevent a user (200) from inadvertently touching the housing 531 while hot.

In the illustrative embodiment of FIG. 5, the electrical connector 530 also includes optional thermally conductive terminals 553,554 that are coupled to the housing 531 so as to transfer heat from the housing 531 to the thermally conductive terminals 553,554. Thermally conductive terminals 553,554 can optionally be used to increase the thermally conductive surface area of the housing 531. The thermally conductive terminals 553,554 can be located at various points along the housing 531. Additionally, while two thermally conductive terminals 553,554 are shown, the housing 531 can include one, two, three, or more thermally conductive terminals instead.

In one embodiment, the thermally conductive terminals 553,554 can protrude from the electrical connector 530 and mate with complementary recesses in a complementary electrical connector to increase the efficiency of the thermal transfer occurring between the corresponding connectors. The thermally conductive terminals 553,554 can be manufactured from the same material as the housing 531 or different materials.

Turning now to FIG. 6, illustrated therein is a perspective and sectional view of a connector system 600 employing complementary connectors 630,660 configured in accordance with one or more embodiments of the invention. A first electrical connector 630 includes a thermally conductive connector housing 631. A second electrical connector portion 660 has a second connector housing 661 that is complementary to the first thermally conductive connector housing 631. In one or more embodiments, the second connector housing 661 is thermally conductive as well. The first thermally conductive connector housing 631 in this illustrative embodiment is adapted to mate to the second connector housing 661.

A first thermal conductor 632 couples the first thermally conductive connector housing 631 to a heat generating circuit component disposed within an electrical device. Examples of heat generating components include processors, control circuits, transceivers, data communication circuits, display drivers, and so forth. The first thermal conductor 632 is configured to draw heat from the heat generating circuit component to the first thermally conductive connector housing 631.

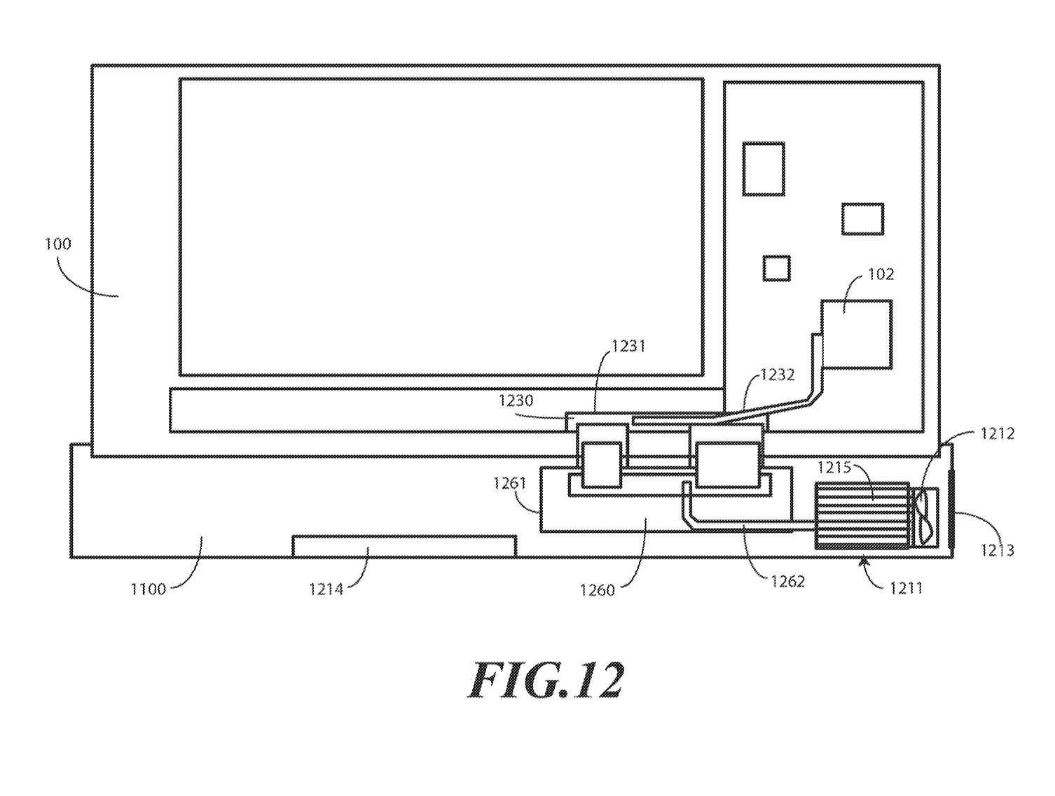

Similarly, a second thermal conductor 662 couples the second connector housing 661 to a heat-sinking element disposed in a peripheral device. Examples of heat-sinking elements included heat sinks, convection-bladed heat sinks, fans, and so forth. When the first electrical connector 630 is coupled to the second electrical connector portion 660, the first thermally conductive connector housing 631 is configured to deliver the heat to the second connector housing 661. The second thermal conductor 662 is then configured to draw the heat from the second connector housing 661 to the heat-sinking element to which it is coupled. In some embodiments, the heat-sinking element will include a fan, an air intake, and an exhaust port, as will be shown for example in FIG. 12 below. Where the heat-sinking element is so configured, the fan can be configured to draw air from the air intake to the exhaust port.

The heat-sinking element can also comprise a heat sink, which can be coupled to the second thermal conductor 662. The heat sink can comprise one or more convection blades. Where so configured, the fan can be configured to draw air across one or more of the convection blades of the heat sink to draw heat from the second thermal conductor 662 out of the secondary device.

In the illustrative embodiment of FIG. 6, the first electrical connector 630 includes an electrical connector portion 633 configured to deliver data 666 to a complementary electrical connector portion 663 of the second electrical connector portion 660. Additionally, the complementary electrical connector portion 663 can be configured to deliver power 667, which can be used by the heat generating circuit component, to the electrical connector portion 633. Of course, the conventions can be reversed as well. The first electrical connector portion 633 can be configured to receive, or optionally transceive, data 666 from or with a complementary electrical connector portion 663 of the second electrical connector portion 660. Similarly, the complementary electrical connector portion 663 can be configured to draw power 667 from the electrical connector portion 633.

As shown in the sectional view of FIG. 6, the first electrical connector 630 and the second electrical connector portion 660 are configured to mate with a mechanically resistive fit, which is known as a “resistance fit.” This means that the first thermally conductive connector housing 631 is geometrically configured to physically contact a substantial surface area of the second electrical connector housing 661 so as to provide a relatively large surface across which heat may be transferred. Using design tolerances in design and manufacture to achieve the resistance fit is but one option suitable for creating a thermal connection between the connector housings.

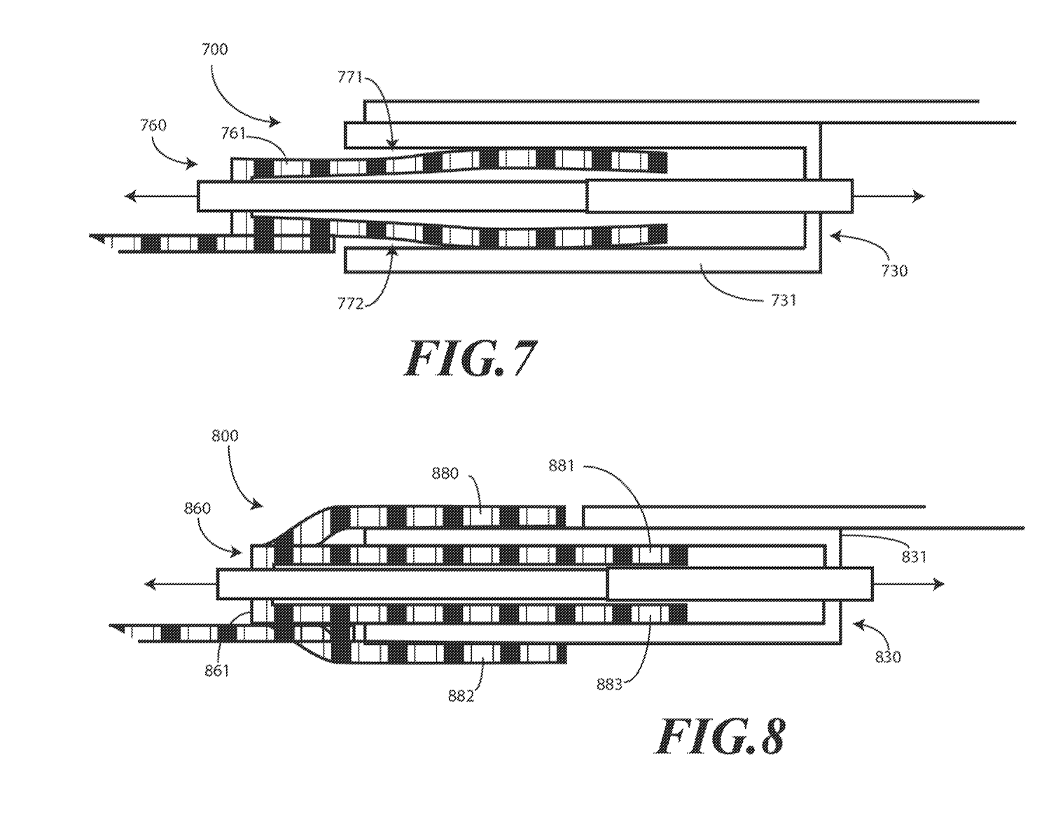

Turning now to FIG. 7, illustrated therein is an alternate connector assembly 700 employing complementary connectors 730,760 configured in accordance with one or more embodiments of the invention. As with previous embodiments, the first electrical connector 730 includes a thermally conductive connector housing 731. The second electrical connector 760 has a second thermally conductive connector housing 761 that is complementary to the first thermally conductive connector housing 731 and is thermally conductive as well. The first thermally conductive connector housing 731 in this illustrative embodiment is adapted to mate to the second thermally conductive connector housing 761.

To assist in forming the resistance fit between the first thermally conductive connector housing 731 and the second thermally conductive connector housing 761, the second thermally conductive connector housing 761 comprises one or more preloaded elements 771,772 that configured to exert pressure against the complementary housing, i.e., the first thermally conductive connector housing 731, when the second thermally conductive connector housing 761 is mated with the first thermally conductive connector housing 731. In this illustrative embodiment, the preloaded elements 771,772 are constructed by using a thermally conductive, springy material for the second thermally conductive connector housing 761 and bending portions of the second thermally conductive housing such that they are preloaded to exert force against the first thermally conductive connector housing 731. Note that while the second thermally conductive connector housing 761 is shown as comprising the preloaded elements 771,772 while the first thermally conductive connector housing 731 is in a more standard configuration, the opposite could be true. The first thermally conductive connector housing 731 could have included preloaded elements while the second thermally conductive connector housing 761 is configured in a more standard configuration. Alternatively, both the first thermally conductive connector housing 731 and the second thermally conductive connector housing 761 could have complementary preloaded elements configured to press against each other when the respective connectors mate.

Turning to FIG. 8, illustrated therein is another connector system 800 that offers yet another design for achieving a suitable resistance fit. As shown in FIG. 8, the connector assembly includes complementary connectors 830,860 configured in accordance with one or more embodiments of the invention. As with previous embodiments, the first electrical connector 830 includes a thermally conductive connector housing 831. The second electrical connector 860 has a second thermally conductive connector housing 861 that is complementary to the first thermally conductive connector housing 831 and is thermally conductive as well. The first thermally conductive connector housing 831 in this illustrative embodiment is adapted to mate to the second thermally conductive connector housing 861.

To assist in forming the resistance fit between the first thermally conductive connector housing 831 and the second thermally conductive connector housing 861, the second thermally conductive connector housing 861 comprises dual engagement members 880,881 and 882,883 that “wrap” about the first thermally conductive connector housing 831. In one embodiment, the dual engagement members 880,881 and 882,883 are preloaded so as to exert a biasing force against the sides of the first thermally conductive connector housing 831 so as to exert pressure against the sides of the first thermally conductive connector housing 831 when the second thermally conductive connector housing 861 is mated with the first thermally conductive connector housing 831. Alternatively, the sides of the first thermally conductive connector housing 831 can be preloaded so as to exert force against one or both of the dual engagement members 880,881 and 882,883. For example, where the sides of the first thermally conductive connector housing 831 is configured in a curved or S-shape, when engaged into the dual engagement members 880,881 and 882,883 the dual engagement members 880,881 and 882,883 would tend to try and straighten these curves. Accordingly, the curves provide a preloading configuration that applies increased contact force between the sides of the first thermally conductive connector housing 831 and the dual engagement members 880,881 and 882,883. Note also that while one connector housing is shown as having the dual engagement members 880,881 and 882,883, the other connector housing could equally have dual engagement members. Moreover, both connectors can have dual engagement members.

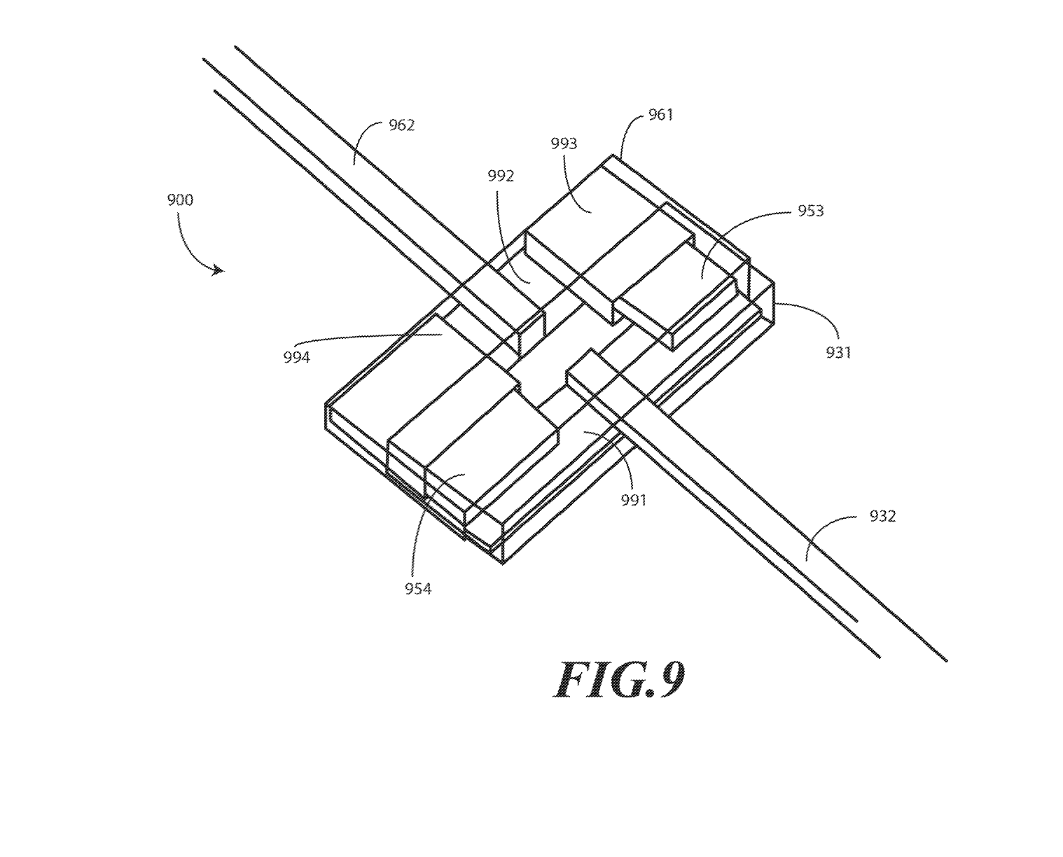

Turning now to FIG. 9, illustrated therein is a see-through perspective view of another connector assembly 900 employing thermally conductive terminals 953,954 to enhance the transport of heat from a first thermally conductive connector housing 931 to a second thermally conductive connector housing 961. As previously described, a thermal conduit 932 runs between the first thermally conductive connector housing 931 and heat-generating components disposed within an electronic device. Similarly, a second thermal conduit 962 runs between the second thermally conductive connector housing 961 and a heat-sinking device.

Each thermal conduit 932,962 couples to its respective thermally conductive connector housing 931,961 via a thermal coupler 991,992. In one embodiment, the thermal coupler 991,992 is a bar of material having a high thermal conductivity. In some embodiments, the thermal coupler 991,992 is manufactured from the same material as the thermally conductive connector housing 931,961. In other embodiments, the thermal coupler 991,992 is manufactured from a different material.

The thermal coupler 991 of the first thermally conductive connector housing 931 is coupled to thermally conductive terminals 953,954. The thermal coupler 992 of the second thermally conductive connector housing 961 is coupled to complementary thermally conductive recesses 993,994. When the first thermally conductive connector housing 931 engages the second thermally conductive connector housing 961, the thermally conductive terminals 953,954 engage the complementary thermally conductive recesses 993,994. In one embodiment, the thermally conductive terminals 953,954 engage the complementary thermally conductive recesses 993,994 with a resistance fit. In one embodiment, one or both of the thermally conductive terminals 953,954 and complementary thermally conductive recesses 993,994 is preloaded so as to bias against the complementary component. This connection increases the efficiency of thermal transfer occurring between the first thermally conductive connector housing 931 and the second thermally conductive connector housing 961. Note that the electrical components—the electrical connection portion, electrical contacts, etc.—which are present, are not shown in FIG. 9 for the sake of simplicity.

Turning now to FIG. 10, illustrated therein is a cut-away view of a portable electronic device 100 being coupled to a peripheral device 300 as was described in FIG. 3 above. The cutaway view shows the components of a thermal management system employing electrical connectors configured in accordance with embodiments of the invention in operation.

The portable electronic device 100 includes a first electrical connector 1030 having a first connector housing 1031. A first thermal coupler 1032 couples the first connector housing 1031 and a heat generating circuit component 1010 disposed within the portable electronic device 100.

The peripheral device 300 includes a second electrical connector 1060 having a second thermally conductive connector housing 1061 that is complementary to the first thermally conductive connector housing 1031. The first electrical connector 930 additionally includes an electrical connector portion (not shown for simplicity) configured to deliver data to a complementary electrical connector portion (also not shown for simplicity) of the second electrical connector 1060. In one or more embodiments the electrical connector portions are further configured to deliver power for the heat generating circuit component as well.

Disposed within the peripheral device 300 is a heat-sinking element 1011. In this illustrative embodiment, the heat-sinking element 1011 includes a fan 1012 and an exhaust port 1013. The illustrative peripheral device 300 of FIG. 10 further includes an air intake 1014. In this illustrative embodiment, the fan 1012 is configured to draw air from the air intake 1014 to the exhaust port 1013. The heat-sinking element 1011 can optionally include a heat sink 1015 as well. The illustrative heat sink 1015 of FIG. 10 includes one or more convection blades 1016. The fan 1012 can be configured to draw the air across the one or more convection blades 1016 of the heat sink 1015.

A second thermal conduit 1062 thermally couples the second thermally conductive connector housing 1061 and the heat-sinking element 1011. The first thermal conduit 1032 is configured to draw heat from the heat generating circuit component 1010 to the first thermally conductive connector housing 1031. The first thermally conductive connector housing 1031 is then configured to deliver the heat to the second thermally conductive connector housing 1061 when the first electrical connector 1030 is coupled to the second electrical connector 1060. In this illustrative embodiment, thermally conductive terminals 1053,1054 engage the complementary thermally conductive recesses 1093,1094 to increase the efficiency of thermal transfer. The second thermal conduit 1062 is then configured to draw the heat from the second electrical connector 1060 to the heat-sinking element 1011.

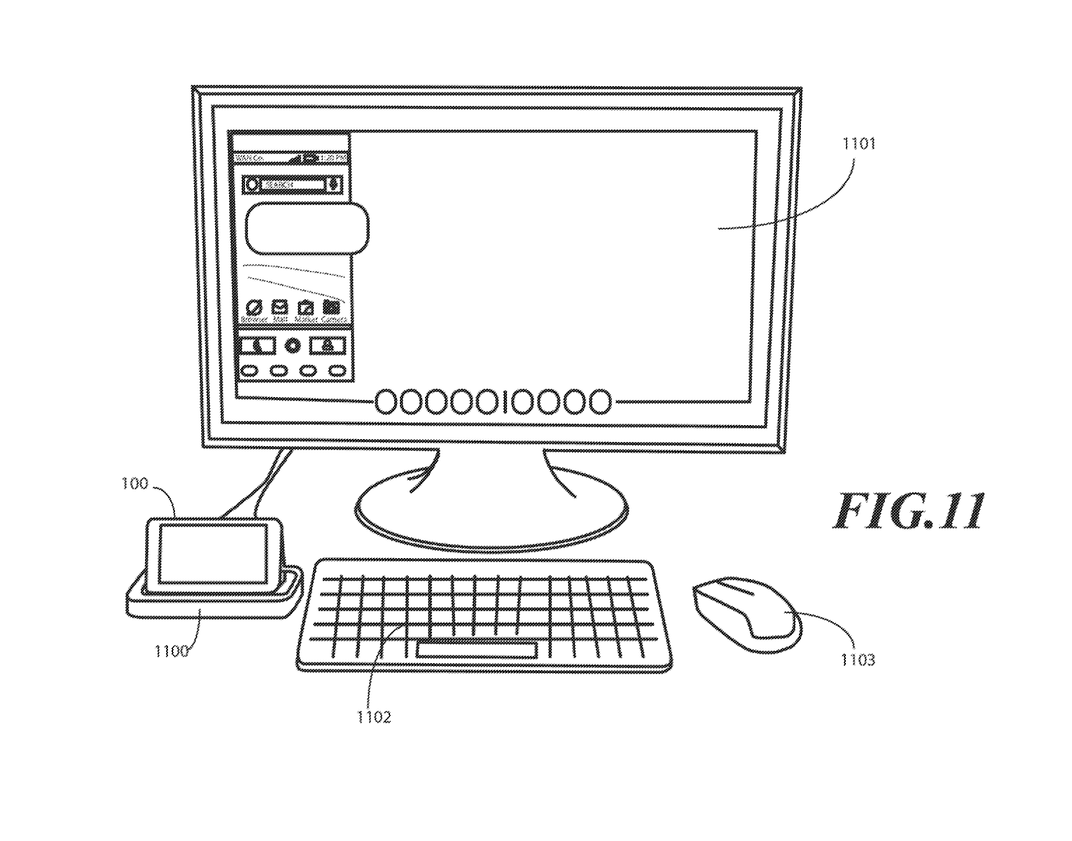

Turning now to FIG. 11, to provide an environmental context regarding one application in which embodiments of the invention may be used, a portable electronic device 100 has been docked in a docking station 1100 coupled by a wire to an external display 1101, a separate, full QWERTY keyboard 1102, and a mouse 1103. In one embodiment, coupling the portable electronic device to the docking station 1100 causes the one or more processors (102) of the portable electronic device 100 to launch the second operating system environment (116) described above. Applications configured for operation in the second operating system environment (116) can be presented on the external display 1101. In the system of FIG. 11, the portable electronic device 100 couples to the docking station 1100 to resemble a traditional desktop computer. However, processing power is provided by the one or more processors (102) of the portable electronic device 100. This enhanced processing power requires that heat be transferred out of the portable electronic device.

Turning to FIG. 12, this cut-away view illustrates how this heat removal is accomplished. The portable electronic device 100 includes a first electrical connector 1230 having a first connector housing 1231. A first thermal coupler 1232 couples the first connector housing 1231 and one or more processors 102 disposed within the portable electronic device 100.

The docking station 1100 includes a second electrical connector 1260 having a second connector housing 1261 that is complementary to the first connector housing 1231. Disposed within the docking station 1100 is a heat-sinking element 1211. In this illustrative embodiment, the heat-sinking element 1211 includes a fan 1212, heat sink 1215, air intake 1214, and an exhaust port 1213.

A second thermal coupler 1262 thermally couples the second connector housing 1261 and the heat-sinking element 1211. The first thermal coupler 1232 is configured to draw heat from the heat generating circuit component 1210 to the first connector housing 1231. The first connector housing 1231 is then configured to deliver the heat to the second connector housing 1261 when the first electrical connector 1230 is coupled to the second electrical connector 1260. The second thermal coupler 1262 is then configured to draw the heat from the second connector housing 1261 to the heat-sinking element 1211.

To show some of the versatility of embodiments of the invention, and turning now to FIG. 13, illustrated therein is a portable electronic device 100 coupled to a cable connector 1300. The illustrative cable connector 1300 of FIG. 13 is configured as a HDMI adaptor, with an HDMI cable 1335 being coupled to the cable connector 1300.

As with previous embodiments, the portable electronic device 100 includes a first electrical connector 1330 having a first connector housing 1331. A first thermal coupler 1332 couples the first connector housing 1331 to a heat generating active component 1310 disposed within the portable electronic device 100.

The cable connector 1300 includes a second electrical connector 1360 having a second connector housing 1361 that is complementary to the first connector housing 1331. Disposed within the cable connector 1300 is a heat-sinking element 1311. In this illustrative embodiment, the heat-sinking element 1311 is configured as a simple coiling of the second thermal coupler 1362, which is connected to the second connector housing 1361. The cable connector 1300 also includes a fan 1312, air intake 1314, and an exhaust port 1313.

The first thermal coupler 1332 is configured to draw heat from the heat generating active component 1310 to the first connector housing 1331. The first connector housing 1331 is then configured to deliver the heat to the second connector housing 1361 when the first electrical connector 1330 is coupled to the second electrical connector 1360. The second thermal coupler 1362 is then configured to draw the heat from the second connector housing 1361 to the coil near the fan for dissipation through the exhaust port 1313.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. An electrical connector, comprising:
an electrical connection portion comprising one or more electrical contacts;
a housing; and
a thermal conduit mechanically coupled to the housing at a connection;
wherein the connection is configured to transfer heat between the thermal conduit and the housing.

2. The electrical connector of claim 1, wherein the housing is adapted to mate to a complementary housing.

3. The electrical connector of claim 2, wherein the housing comprises one or more preloaded elements configured to exert pressure against the complementary housing when the housing is mated with the complementary housing.

4. The electrical connector of claim 1, wherein the housing comprises a thermally insulating covering disposed about the housing.

5. The electrical connector of claim 1, wherein the housing is manufactured from a thermally conductive material comprising one or more of copper, aluminum, or alloys thereof.

6. An electrical device, comprising:
an electrical connector having a housing disposed about electrical contacts;
a circuit component configured to generate heat when operable; and
a thermal conduit coupling the housing and the circuit component such that the heat is transferred from the circuit component to the housing.

7. The electrical device of claim 6, wherein the electrical connector is recessed into the electrical device such that an insertion port of the electrical connector is flush with a major face of the electrical device.

8. The electrical device of claim 6, wherein the thermal conduit comprises a heat pipe.

9. The electrical device of claim 6, wherein the thermal conduit comprises a carbon-based film.

10. A system, comprising:
a first electronic device comprising:
a first electrical connector having a first connector housing;
a heat generating circuit component; and
a first thermal conductor coupling the first connector housing and the heat generating circuit component;
a second electronic device comprising:
a second electrical connector having a second connector housing that is complementary to the first connector housing;
a heat-sinking element; and
a second thermal conductor coupling the second connector housing and the heat-sinking element.

11. The system of claim 10, wherein the first thermal conductor is configured to draw heat from the heat generating circuit component to the first connector housing.

12. The system of claim 11, wherein the first connector housing is configured to deliver the heat to the second connector housing when the first electrical connector is coupled to the second electrical connector.

13. The system of claim 12, wherein the second thermal conductor is configured to draw the heat from the second connector housing.

14. The system of claim 13, wherein the heat-sinking element comprises a fan and an exhaust port.

15. The system of claim 14, wherein the second electronic device comprises an air intake, wherein the fan is configured to draw air from the air intake to the exhaust port.

16. The system of claim 10, wherein the heat-sinking element further comprises a heat sink coupled to the second thermal conductor.

17. The system of claim 16, wherein the heat sink comprises one or more convection blades, wherein a fan is further configured to draw air across the one or more convection blades of the heat sink.

18. The system of claim 15, wherein the first electrical connector comprises an electrical connector portion configured to deliver data to a complementary electrical connector portion of the second electrical connector.

19. The system of claim 18, wherein the complementary electrical connector portion is configured to deliver power for the heat generating circuit component to the electrical connector portion.

20. The system of claim 10, wherein the second electrical connector is configured to mate with the first electrical connector with a resistance fit.
